(19) United States
(12) Patent Application Publication
(10) Pub. No.: US 2024/0303464 A1
(43) Pub. Date: Sep. 12, 2024

(54) Implementing and Training Computational Efficient Neural Network Architectures Utilizing Layer-Skip Logic

(71) Applicant: Google LLC, Mountain View, CA (US)

(72) Inventors: Nan Du, San Jose, CA (US); Tao Wang, Sunnyvale, CA (US); Yanqi Zhou, Hillsborough, CA (US); Tao Lei, Sunnyvale, CA (US); Yuanzhong Xu, Mountain View, CA (US); Andrew Mingbo Dai, San Francisco, CA (US); Zhifeng Chen, Sunnyvale, CA (US); Dewen Zeng, Mishawaka, IN (US); Yingwei Cui, Palo Alto, CA (US)

(21) Appl. No.: 18/598,876

(22) Filed: Mar. 7, 2024

Related U.S. Application Data
(60) Provisional application No. 63/488,901, filed on Mar. 7, 2023.

(51) Int. Cl. G06N 3/04; G06N 3/084

(52) U.S. Cl. CPC G06N 3/04; G06N 3/084

(57) ABSTRACT

A method includes providing a first set of data objects to a first skip router of a neural network (NN). The NN includes a first NN layer and a second NN layer. The first set of data objects is subdivided into a first set of skip objects and a first set of non-skip objects based on a first skip logic implemented by the first skip router and a first context of each data object in the first set of data objects. A first set of processed objects is generated based on the first set of non-skip objects and a first layer logic implemented by the first NN layer. Predictions are generated based on a second set of data objects and a second layer logic implemented by the second NN layer. The second set of data objects includes the first set of processed objects and the first set of skip objects.

### PRIORITY CLAIM

The present application is based on and claims priority to U.S. Provisional Application 63/488,901 having a filing date of Mar. 7, 2023, which is incorporated by reference herein.

### FIELD

The present disclosure relates generally to neural networks. More particularly, the present disclosure relates to implementing and training neural network architectures that utilize layer-skip logic that enables computational efficiency BACKGROUND

Transformer-based large scale language models trained with general corpus have shown tremendous improvement of generalization in particular with in-context few-shot learning in recent years. Despite of the impressive capability of text generation, training and serving these giant models are non-trivial even with the recent progress of hardware and software. One of the major challenges is that the processing of each input requires to activate all the parameters of a model, which often leads to trillions of floating point operations (FLOPs) per prediction. This imposes a big burden on both model training and inference since there is no control over the amount of computation that can be assigned to each input example.

### SUMMARY

Aspects and advantages of embodiments of the present disclosure will be set forth in part in the following description, or can be learned from the description, or can be learned through practice of the embodiments.

One example aspect of the present disclosure is directed to a method that includes providing a first set of data objects to a first skip router of a neural network (NN). The NN further includes a first NN layer and a second NN layer. The first set of data objects is subdivided into a first set of skip objects and a first set of non-skip objects based on a first skip logic implemented by the first skip router and a first context of each data object in the first set of data objects. A first set of processed objects is generated based on the first set of non-skip objects and a first layer logic implemented by the first NN layer. One or more predictions are generated based on a second set of data objects and a second layer logic implemented by the second NN layer. The second set of data objects includes the first set of processed objects and the first set of skip objects.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that implements and trains a computational efficient neural network according to example embodiments of the present disclosure according to example embodiments of the present disclosure.

FIG. 1B depicts a block diagram of an example computing device that implements and trains a computational efficient neural network according to example embodiments of the present disclosure according to example embodiments of the present disclosure.

FIG. 1C depicts a block diagram of an example computing device that implements and trains a computational efficient neural network according to example embodiments of the present disclosure according to example embodiments of the present disclosure.

FIG. 2 depicts a flow chart diagram of an example method to perform according to example embodiments of the present disclosure.

FIG. 3A shows an overall framework for the embodiments.

FIG. 3B shows a softmax function being employed for the router function, according to various embodiments.

FIG. 4 shows an overview of an efficient implementation of the embodiments based on dynamic gather and scatter.

FIG. 5 shows an overview of a skip layer being applied to a transformer-based model, according to various embodiments.

FIG. 6 provides pseudo code for a first algorithm that is directed to a forward pass skip layer, according to the various embodiments.

FIG. 7 provides pseudo code for a second algorithm that is directed to a skip layer per decoding step, according to the various embodiments.

Reference numerals that are repeated across plural figures are intended to identify the same features in various implementations.

### DETAILED DESCRIPTION

### Overview

Generally, the present disclosure is directed to implementing and training neural network architectures that utilize layer-skip logic that enables computational efficiency. The various neural network architectures may implement a transformer model. The transformer model may be employed for natural language (NL) tasks. The proposed neural network architectures significantly reduce time and space complexity in the training of the implemented model. The trained model can be utilized for various predictive tasks (e.g., natural language processing (NLP) tasks).

Transformer-based large scale language models trained with general corpus have shown tremendous improvement of generalization in particular with in-context few-shot learning in recent years. Despite of the impressive capability of text generation, training and serving these giant models are non-trivial even with the recent progress of hardware and software. One of the major challenges is that the processing of each input requires to activate all the parameters of a model, which often leads to trillions of floating-point operations (FLOPs) per prediction. This imposes a big burden on both model training and inference since there is no control over the amount of computation that can be assigned to each input example.

In particular, allocating the same computational power of a large model uniformly for processing all samples tend to be wasteful and less efficient. These issues are even more exacerbated when training large models using real-world data corpus in that the redundancy of trivial examples will be more pronounced as more and more data are used.

In contrast to other transformer models, example model architectures described herein can operate to adjust the computational performance of the model depending on the ‘hardness’ of the input. Specifically, the proposed architectures may only need a lower amount of computational cost to process ‘easy’ examples, like the commonly used stop-words, punctuation, patches in the background of an image, etc. However, the architecture can adjust to allow additional processing (e.g., more computational cost) for ‘hard’ examples, e.g., a rare abstract concept, when they are truly needed.

More generally, aspects of the present disclosure leverage conditional computation, which is the paradigm where only a small subset of the model parameters are activated based on the input representation, thereby reducing the amount of computation needed per example. However, due to the discreteness of the decisions based on each input, training the models with conditionally activated components end-to-end differentiably and efficiently is still challenging and, therefore, solutions are provided to this challenge herein.

In particular, in this disclosure, a framework is developed, referred to as the skip layer logic model (SLLM), which allows an input to skip any layer that can be wrapped inside it conditioned on the contextual representation. More specifically, example models that employ SLLM can be trained end-to-end differentiably while at the same time the discrete decisions during the forward pass can still be respected, which enables the proposed models to precisely control the performance-compute tradeoff through external constraints.

Moreover, because the discrete decisions can be preserved during the forward pass, an efficient implementation is also developed so that the additional computation can be further saved in both pretraining and inference for the given target budget. In one example application, the SLLM is applied to the transformer architecture to demonstrate the efficiency of the method for decode language model pretraining and decoding. Various methods of the embodiments are evaluated on a suite of NLP benchmarks ranging from open-domain QA tasks, reading comprehension, common sense reasoning, to natural language inference tasks. Models with SLLM have shown strong 1-shot performance with controllable computation tradeoff between model quality and decoding efficiency compared to a variety of competitive baselines.

Although many of the embodiments are discussed in conjunction with the SLLMs being applied to neural networks trained for various NLP tasks, the embodiments are not so limited. The embodiments may be applied to any neural network application that receives input data that is sequential in nature. The tokens in a NLP phrase (e.g., a paragraph, a sentence, or a sentence fragment) are typically provided to a SLLM-based neural network architecture as a sequential input. Each token may be embedded in a vector embedding, and the sequence of token embeddings may be fed to a neural network. Likewise, the embodiments may be employed for sequential genetic sequences. In such embodiments, certain segments of a genetic sequence may be able to skip various layers of the SLLM-based neural network, depending on the contexts of atoms of the genetic sequence. The embodiments may be employed for other sequential input data-based applications, such as but not limited to signal processing, genomics, autonomous vehicles, computer vision, and the like.

Aspects of the present disclosure provide a number of technical effects and benefits. As one example technical effect and benefit, computational efficiency for pretraining, training, and employing predictive models is significantly reduced via the skip logic. That is, the space and time complexity for pretraining, training, and employing predictive models is significantly reduced because the computation for each data objected (e.g., a vector embedding of a NL token) is significantly reduced based on the context of the data object. As a result, the usage of computing resources can be reduced. For example, the number of processor cycles can be reduced, the usage of computer memory can be reduced, and/or the usage of network bandwidth can be reduced.

With reference now to the Figures, example embodiments of the present disclosure will be discussed in further detail.

### Example Devices and Systems

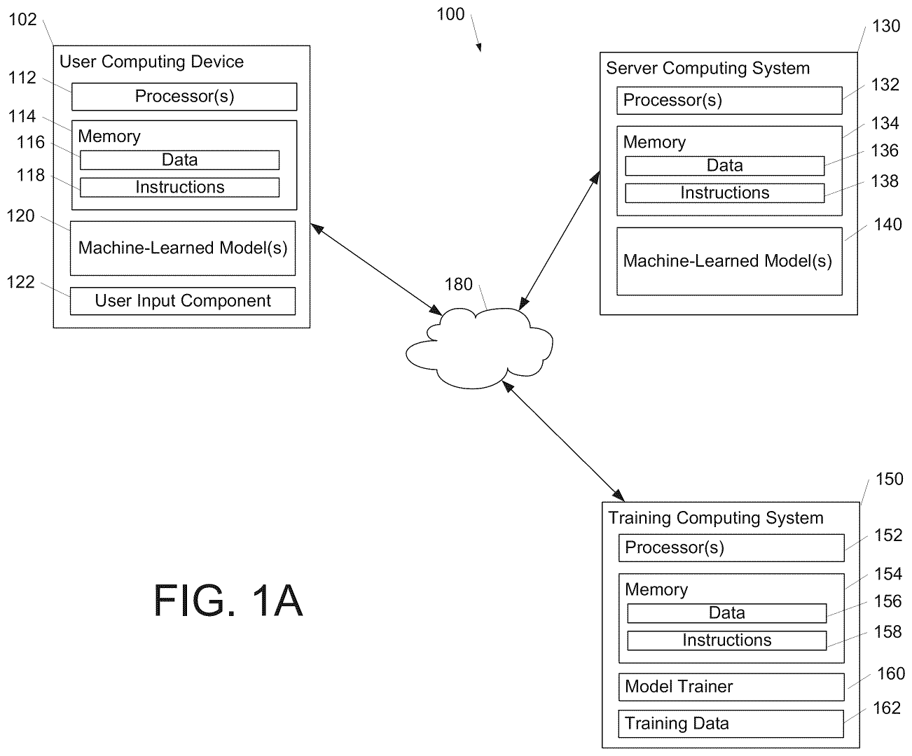

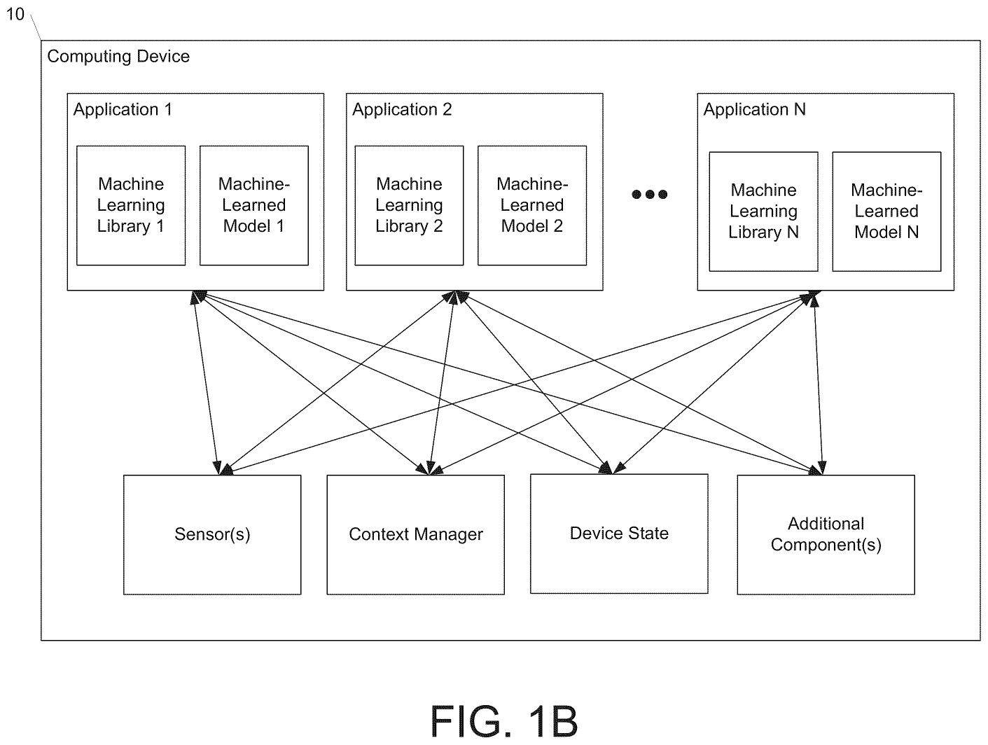

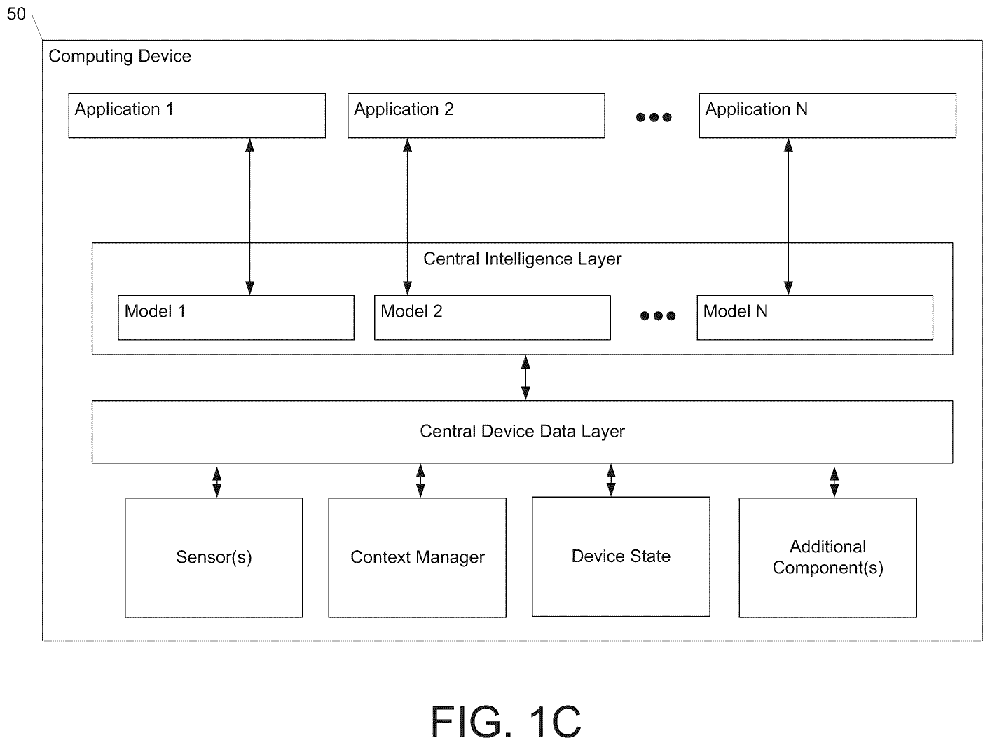

FIG. 1A depicts a block diagram of an example computing system 100 that implements and trains a computational efficient neural network according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120.

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Methods

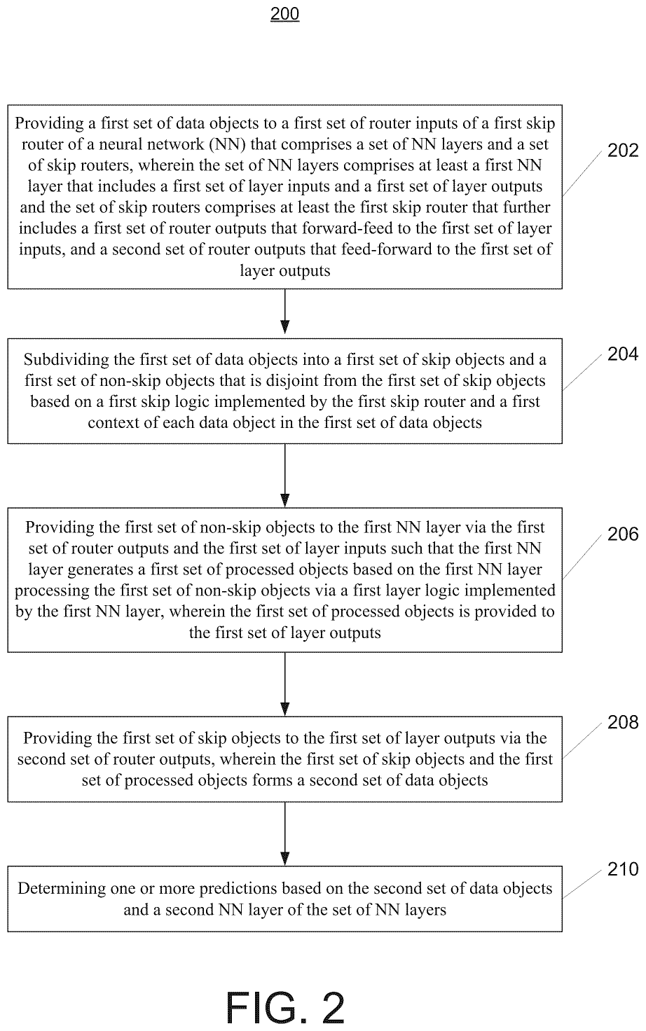

FIG. 2 depicts a flow chart diagram of an example method 200 to perform according to example embodiments of the present disclosure. Although FIG. 2 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

Method 200 may be performed by a computing system that includes one or more processors and one or more non-transitory computer-readable media. The media may store instructions that when executed by the one or more processors, cause the computer system to perform operations comprising those of the blocks of method 200.

At block 202, the computing system may provide a first set of data objects to a first set of router inputs of a first skip router of a neural network (NN) implemented by the computing system. The NN may comprise a set of NN layers and a set of skip routers. The set of NN layers comprises at least a first NN layer that includes a first set of layer inputs and first set of layer outputs. The set of skip routers comprises at least the first skip router that further includes a first set of router outputs that forward-feed to the first set of layer inputs and a second set of router outputs that feed-forward to the first set of layer outputs.

At block 204, the computing system may subdivide the first set of data objects into a first set of skip objects and a first set of non-skip objects that is disjoint from the first set of skip objects. Subdividing the first set of data objects may be based on a first skip logic implemented by the first skip router and a first context of each data object in the first set of data objects.

At block 206, the computing system may provide the first set of non-skip objects to the first NN layer via the first set of router outputs and the first set of layer inputs. The first NN layer may generate a first set of processed objects based on the first NN layer processing the first set of non-skip objects via a first layer logic implemented by the first NN layer. The first set of processed objects is provided to the first set of layer outputs.

At block 208, the computing system may provide the first set of skip objects to the first set of layer outputs via the second set of router outputs. The first set of skip objects and the first set of processed objects may form a second set of data objects.

At block 210, the computing system may determine one or more predictions based on the second set of data objects and a second NN layer of the set of NN layers.

In some embodiments, the second NN layer includes a second set of layer inputs and a second set of layer outputs. The set of skip routers further comprises a second skip router that includes a second set of router inputs, a third set of router outputs that forward-feed to the second set of layer inputs, and a fourth set of router outputs that feed-forward to the second set of layer outputs. The first set of layer outputs feed-forward to the second set of router inputs.

The computing system may provide the second set of the data objects to the second skip router via the first set of layer outputs and the second set of router inputs. The computing system may further subdivide the second set of data objects into a second set of skip objects and a second set of non-skip objects that is disjoint from the second set of skip objects. Subdividing the computing system may be based on a second skip logic implemented by the second skip router and a second context of each data object in the second set of data objects. The computing system may provide the second set of non-skip objects to the second NN layer via the third set of router outputs and the second set of layer inputs. The second NN layer generates a second set of processed objects based on the second NN layer processing the second set of non-skip objects via a second layer logic implemented by the second NN layer. The second set of processed objects is provided to the second set of layer outputs. The computing system may provide the second set of skip objects to the second set of layer outputs via the fourth set of router outputs. The second set of skip objects and the second set of processed objects forms a third set of data objects. The computing system may determine the one or more predictions based on the third set of data objects and a third NN layer of the set of NN layers.

In various embodiments, the first NN layer is a first feed-forward layer (FFL) of the set of NN layers. The computing system may subdivide the first set of non-skip objects into a first subset of non-skip objects and the second subset of non-skip objects that is disjoint from the first set of non-skip objects. The computing system may provide the first subset of non-skip objects to the first FFL. The second subset of non-skip objects is provided to the first FFL. The first subset of non-skip objects is provided to the first FFL in series with the second subset of non-skip objects being provided to first FFL. The first subset of non-skip objects includes at least a first non-skip object and a second non-skip object. The second subset of non-skip objects includes at least a third non-skip object and a fourth non-skip object. The computing system provides the first non-skip object and the third non-skip object to a first implementation of the first FFL. The second non-skip object and the fourth non-skip object are provided to a second implementation of the first FFL

The first non-skip object is provided to the first implementation of the first FLL in parallel to the second non-skip object being provided to the second implementation of the first FLL. The third non-skip object is provided to the first implementation of the first FLL in parallel to the fourth non-skip object being provided to the second implementation of the first FLL. The first non-skip object is provided to the first implementation of the first FLL in series with the third non-skip object being provided to the first implementation of the first FLL. The second non-skip object is provided to the second implementation of the first FLL in series with the fourth non-skip object being provided to the second implementation of the first FLL. A first cardinality of the first subset of non-skip objects and a second cardinality of the second subset of the non-skip objects is indicated by a hyperparameter of the NN.

The first set of data objects is a first ordered set that has a first order. The first set of skip objects is a second ordered set that has a second order based on the first order. The first set of non-skip objects is a third ordered set that has a third order based on the first order. The computing system may form the second set of data objects based on the first order of the first set of data objects, the second order of the first set of skip objects, and the third order of the first set of non-skip objects such that the second set of data objects is a fourth ordered set that has the first order.

In various embodiments, the first NN layer is a first feed-forward layer (FFL) of the set of NN layers. The set of NN layers further comprises a self-attention layer and a first layer-normalization (LN) layer. The computing system may provide the first set of objects to the first LN layer. A key-value pair for each data object of the first set of data objects may be determined based on a first LN logic implemented by the first LN layer. The key-value pair for each data object of the first set of data objects is provided to the self-attention layer. The computing system provides the first set of non-skip objects to the self-attention layer. A self-attention output is generated based on a self-attention logic implemented by the self-attention layer, the key-value pair for each data object of the first set of data objects, and the set of non-skip objects. The first set of processed objects is generated based on the self-attention output and the first layer logic.

The computing system may determine a first LN output based on the first LN logic and the first set of data objects. The first LN output is provided to the first skip router. The computing system subdivides the first set of data objects into the first set of skip objects and the first set of non-skip objects further based on the first LN output. The computing system may determine a query for each non-skip object of the first set of non-skip objects. The query for each non-skip object of the first set of non-skip objects is provided to the self-attention layer. The self-attention output is generated further based on the query for each non-skip object of the first set of non-skip objects. The self-attention output is provided to the second LN layer. A second LN output is determined based on a second LN logic implemented by the second LN layer and a self-attention output. The second LN output is provided to the first FFL. The first set of processed objects is generated further based on the second LN output and the first layer logic.

Each data object of the first set of data objects may be a vector embedding of a natural language (NL) token. The NN may implement a NL transformer model. The one or more predictions may be associated with one or more NL tasks performed by the NL transformer model. The NL transformer model may be a decoder model. The first skip logic and the first layer logic may be jointly trained via a loss function that includes a first term associated with an accuracy of the one or more predictions and a second term associated with a cardinality of the first set of non-skip objects. The second term of the loss function generates a larger penalty when the cardinality of the first set of non-skip objects is larger.

### System Architecture

Skip layers will now be discussed. Let X_{[layer]}^{o}=F_{[layer]}(X [symbol] ) denote a parameterized layers (or module) of a neural network with input X and output X^{o} given and [symbol] optional set of weights represented by [symbol] . For instance, a plain feed forwards layer (FFN) can be denoted by X_{FFN}^{o}=F_{FFN}(X|{Wⁱ, W^{o}}), where Wⁱϵ [symbol] ^{m×h} and W^{o}ϵ [symbol] ^{h×m} are the input and output weights respectively.

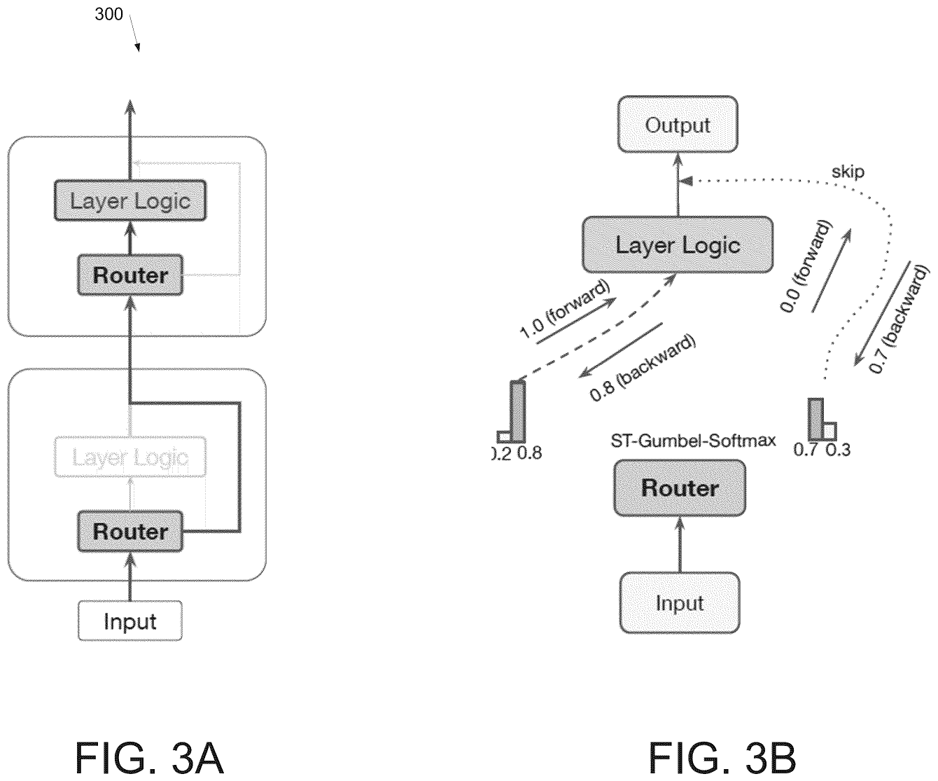

A skip layer may be designed to wrap an existing layer such that

$${X}_{SL}^{o} = {F}_{SL} ( {F}_{[ layer ]} ( X ) \vert {W}_{G} ) = {F}_{[ layer ]} ( X ) ⊙ G ( X \vert {W}_{G} ) + X ⊙ ( 1 - G ( X \vert {W}_{G} ) ) ,$$

where G(X|W_{G})ϵ{0,1} is a router function with the learnable weight W_{G}. FIG. 3A shows an overall framework 300 for the embodiments. More particularly, in FIG. 3A, the router (e.g., a skip router) can determine whether to activate of skip the embedded layer logic based on the input context.

Given a batch Xϵ [symbol] ^{B×T×d} of B sequences, each of length T and the embedding dimension d, for each token input.

$$X [ b , t ] ∈ {ℝ}^{d} , b \leq B , t \leq T , such that$$

$${X}_{SL}^{o} [ b , t ] = \{ \begin{matrix}{F}_{[ layer ]} ( X [ b , t ] ) , if G ( X [ b , t ] ) = 1 \\ X [ b , t ] , otherwise\end{matrix}$$

Therefore, as shown in FIG. 3A, any existing layer applied to the input in a pointwise way (e.g., FFN) can be embedded inside a skip layer. Based on the context, if the router determined to skip, the input will be connected directly to the output, otherwise it will go through the embedded layer logic.

Various functionalities of a router (e.g., a skip router). The routers of the various embodiments implement a router function G(X|W_{G}) which may be learned to assign only a subset of inputs to the embedded layer for the best model performance under a given budget. For a batch of input tokens, the router may output a binary mask matrix

$$M = G ( X \vert {W}_{G} ) ∈ {\{ 0 , 1 \}}^{B \times T} , {W}_{G} ∈ {ℝ}^{d \times 2} .$$

There may be multiple choices for designing G(X|W_{G}). One choice is a sigmoid function G(X|W_{G})=σ(XW_{G}) that independently normalizes each value to be within the continuous range (0, 1) as the soft approximation to the binary masking. Although this approximation may be differentiated, it may need an additional threshold to produce the binary decision rule of the above equation.

Another design choice for the routing function is the Top-K (K=1) routing, e.g., G(X|W_{G})=Top−1(XW_{G})=argmax(XW_{G}). In order to address the indifferentiability of the argmax operator, for each input token X[b, t], the dot-product scores by g=Softmax(X [b, t]W_{G})ϵ [symbol] ² may be normalized. Let

$${X}_{SL}^{o} [ b , t ] = \{ \begin{matrix}g [ 1 ] \cdot {F}_{[ layer ]} ( X [ b , t ] ) , if argmax ( g ) = 1 \\ g [ 0 ] \cdot X [ b , t ] , otherwise\end{matrix}$$

such that the gradients can be backpropagated through the coefficients g.

FIG. 3B shows a softmax function being employed for the router function, according to various embodiments. In FIG. 3B, the router function is employing a Gumbel-Softmax function. In the forward pass, binary variables are sampled. During the backward pass, gradients are backpropagated to update the router. More particularly, in the forward pass, sampled binary values are returned for the gating function G(X[b, t]) as shown above. In the backward pass, the soft probabilities are used as g as shown above for the gradients to be propagated back to update the router weights. Because during the forward pass the percentage of the tokens that are not skipped are calculated based on the binary masking shown above, the density of the model can be controlled.

Router capacity will now be discussed. The binary mask of the router output in the above equation is the assignment of a subset of tokens in a batch in the embedded layer inside a skip layer. For simplicity, assume each sequence in a batch of size B has the same sequence length T. Then, the ratio

$$r = \frac{{\sum }_{i , j} M [ i , j ]}{B \times T}$$

is the percentage (or probability) that a token is assigned to a layer, which may be referred tp as the capacity. Consider P as a global budget of how many tokens can be assigned to a layer. An auxiliary loss term may be introduced, [symbol] ₐᵤₓ=Σᵢ^{L}(rᵢ−P)², where rᵢ is the capacity of layer i≤L, so that each layer will respect the budget constraint. The overall loss function of the model may be [symbol] = [symbol] ₙₗ₁+ [symbol] ₐᵤₓ, where [symbol] ₙₗₗ is the negative log-likelihood of predicting the next token on the average. By optimizing [symbol] , on the one hand, the layer capacity may be pushed closer to the target probability P. On the other hand, the [symbol] ₐᵤₓ term may continuously improve the model's predictive accuracy. Since the [symbol] ₐᵤₓ term will enforce only P percent of a batch of tokens to go with the layer, in order to reduce the first term [symbol] ₙₗₗ, “hard” examples that lead to marginal reduction on average may be prioritized, while “easy” examples that already achieve low perplexity may be skipped in order to save FLOPS.

As discussed below, the embodiments may be efficiently implemented. An advantage of the embodiments includes that the number of inputs computed by each layer is different across the entire stack of layers and continuously varies during training. At the same time, this dynamic characteristic is also challenging for implementation on TPU where computations of tensors with static shapes are often preferred.

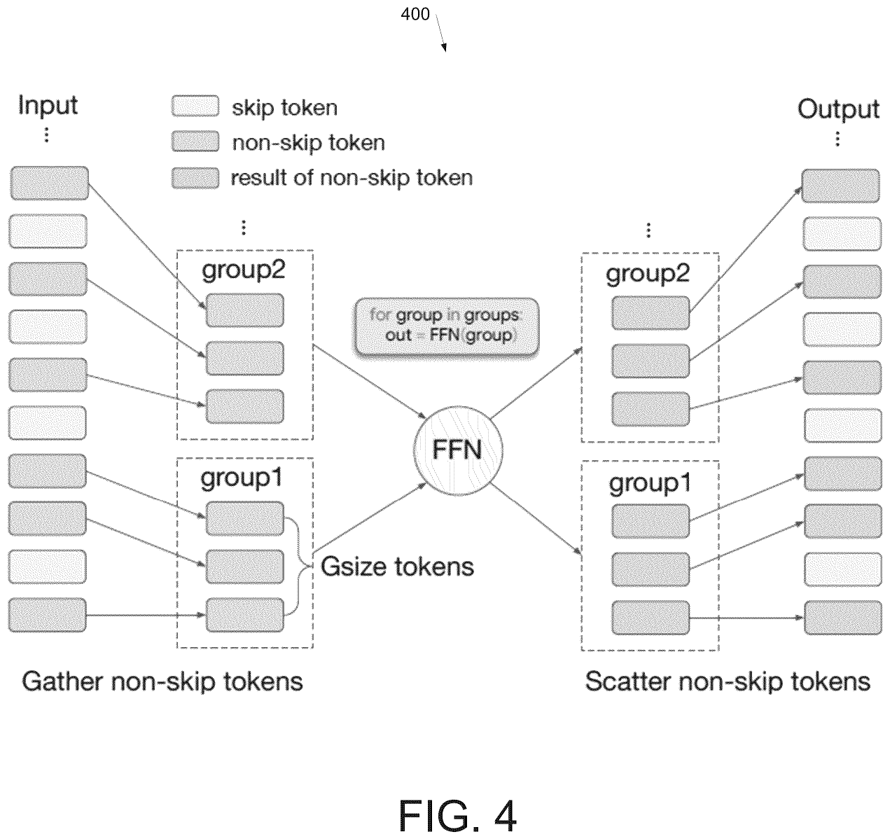

A non-limiting embodiment includes first applying the given layer logic in FIG. 3A to the entire batch and then multiply the output batch with the mask given above so that the skipped tokens will not be used in the layer. However, this masking mechanism is computationally expensive since the embodiments should not spend the same computations on the skipped inputs as those on the non-skipped ones especially when the skip ratio is high. FIG. 4 shows an overview 400 of an efficient implementation of the embodiments based on dynamic gather and scatter. The overview 400 in FIG. 4 focuses on the sparse computation of a FFN layer since it is a widely used component and often computationally intensive. More specifically, the non-skip tokens are gathered based on indices generated by the tourer and then fed into the FFN as groups. The results may be scattered to the final output. The overall algorithm includes three major steps. First, all inputs are marked as skip or non-skip based on results of the router as shown above. Second, all non-skipped inputs (in the shaded rectangles) may be gathered and evenly partitioned into groups. Although each group may be fed into the FFN for computation sequentially, all the elements in the same group may be gathered, computed, and scattered in parallel Thirdly, the compute results from the non-skipped inputs may be scattered back to the final outputs of this FFN layer, while the skipped inputs may be directly written into the final outputs directly without any computation.

The group size (the number of inputs in a group), which may be denoted as Gsize, is a hyper-parameter that controls how many tokens may be processed by the FFN in parallel. Because the number of non-skipped inputs in a batch is dynamic and unknown in advance, Gsize may affect the training efficiency. When Gsize is too large, e.g., a single group, this group may include too many skipped inputs, leading to sub-optimal performance. When Gsize is too small, it may produce too many groups of small size, and the computation may be close to being sequential. Thus, there could be little parallelism, and the overheads maybe even larger than the basic masking implementation. In practice, the embodiments may set Gsize ∝PBT where P is the density, B is the batch size, and T is the sequence length.

Embodiments employing transformer-based models will now be discussed. More particularly, the below discussion focuses on applying skip layers to transformer-based decoder-only language models in the setup of in-context learning. A transformer layer mainly includes the self-attention, layer normalization, and FFN as the sub-layers, and can be represented as:

$${X}^{l ′} = {F}_{Attn} ( {F}_{LN} ( {X}^{l} ) ) + {X}^{l} ,$$

$${X}^{l + 1} = {F}_{FFN} ( {F}_{LN} ( {X}^{l ;} ) ) + {X}^{l ′} .$$

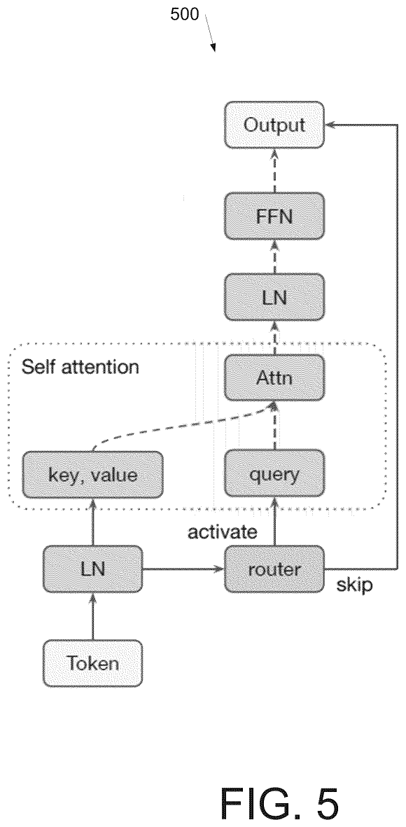

FIG. 5 shows an overview 500 of a skip layer being applied to a transformer-based model, according to various embodiments. More particularly, in FIG. 5, a skip layer is applied to a single layer in the NN implementing the transformer-based model. In FIG. 5, LN represents a layer normalization layer. Also in FIG. 5, query, key, and values refers to the computation of query, key, and value projections in the self-attention layer. Attn refers to the attention computation. Residual connections in the self-attention layer and the FFN layer are ignored in FIG. 5 for simplicity. As noted above, an embodiment (e.g., a skip layer) may be applied to a single transformer layer. Some embodiments include wrapping an entire transformer-based model in a skip layer to preserve the atomicity of the self-attention (F_{Attn})→FFN(F_{FFN}) structure. However, the F_{Attn} layer and the F_{FFN} layer may have different skipping implementations. The F_{FFN} layer may be the most computationally intensive component of a transformer model, but it may be applied to a given batch of tokens in a point-wise manner. Therefore, each input token of a batch can activate the F_{FFN} layer independently with the probability P. Because the F_{FFN} layer can consume significant amounts of the total computation in a transformer layer, the embodiments can achieve significant savings in FLOPS when the activation probability is small.

The self-attention layer F_{Attn} may consume significantly less computations relative to the F_{FFN} layer. However, F_{Attn} may not apply to a batch of tokens in the pointwise way because tokens need to attend to each other to compute their own attention output. If most tokens in a batch are skipped when P is small, the left non-skipped tokens may lose most of the context of the respective sequences they belong to.

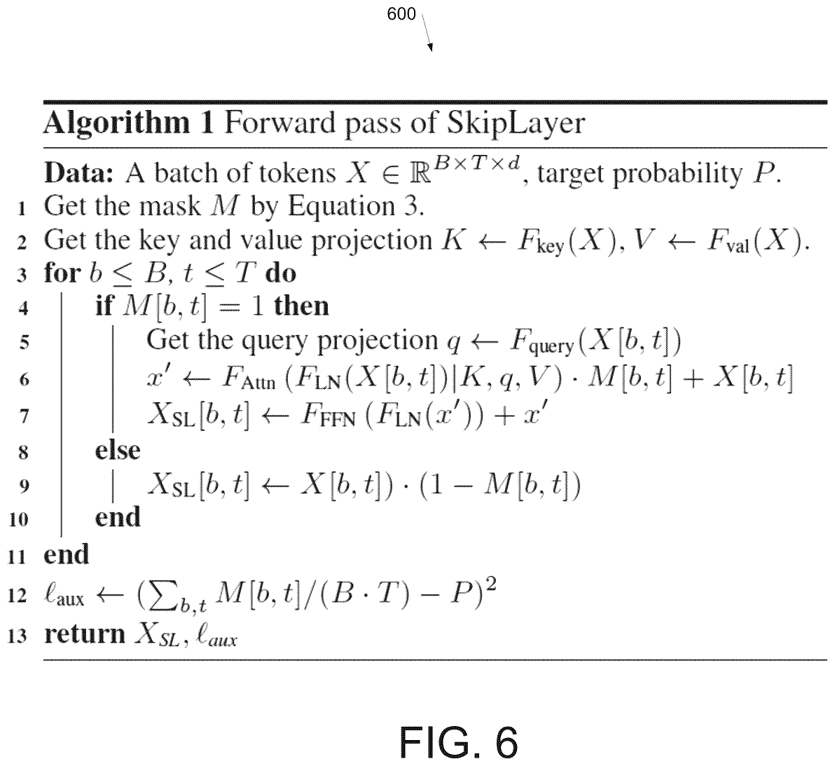

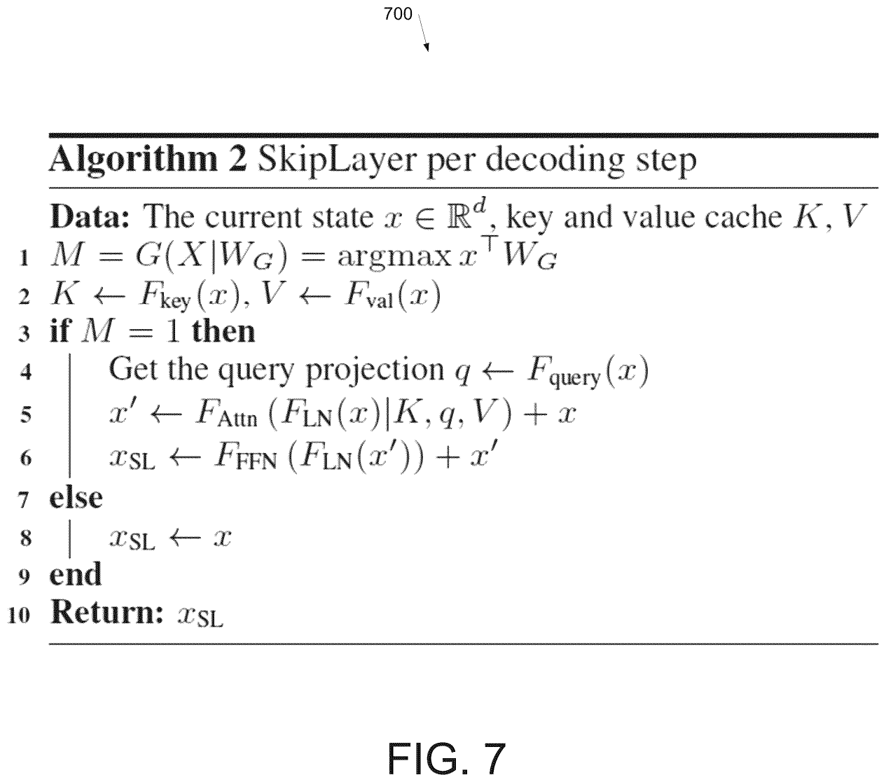

FIG. 6 provides pseudo code for a first algorithm 600 that is directed to a forward pass skip layer, according to the various embodiments. FIG. 7 provides pseudo code for a second algorithm 700 that is directed to a skip layer per decoding step, according to the various embodiments. Some embodiments may follow partial skipping mechanism. As shown in FIG. 5, when the input tokens are skipped, their key and value projections may still be preserved (e.g., see line 2 of the first algorithm 600 of FIG. 6) since they are part of the context and are needed for the rest non-skipped tokens to further attend to. However, because the skipped tokens do not require attention calculations by themselves, we can still omit their query projections. Note that lines 3-11 of the first algorithm 600 may be computed in parallel using the efficient implementation discussed above to increase training speed.

The second algorithm 700 of FIG. 7 shows the greedy decoding logic of one skip layer-based transformer layer. The router makes the skipping decision by picking the most likely outcome. The key and value projections will be computed and saved in the decoding cache (e.g., see line 2 of the second algorithm 700). When the router activates the current layer, the query projection may be computed for the current token, and then the decoding cache K and V which contain the key and value projections of previous decoding steps may be used to compute the self-attention. Otherwise, there may be no further computations from this layer.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system comprising:
one or more processors; and
one or more non-transitory computer-readable media that store instructions that when executed by the one or more processors, cause the computer system to perform operations comprising:
providing a first set of data objects to a first skip router of a neural network (NN) implemented by the computing system, wherein the NN further includes a first NN layer and a second NN layer;
subdividing the first set of data objects into a first set of skip objects and a first set of non-skip objects based on a first skip logic implemented by the first skip router and a first context of each data object in the first set of data objects;
generating a first set of processed objects based on the first set of non-skip objects and a first layer logic implemented by the first NN layer;
determining one or more predictions based on a second set of data objects and a second layer logic implemented by the second NN layer, wherein the second set of data objects includes the first set of processed objects and the first set of skip objects.

2. The computing system of claim 1, wherein the NN further includes a second skip router and a third NN layer, and determining the one or more predictions comprises:
providing the second set of data objects to the second skip router;
subdividing the second set of data objects into a second set of skip objects and a second set of non-skip objects based on a second skip logic implemented by the second skip router and a second context of each data object in the second set of data objects;
generating a second set of processed objects based on the second set of non-skip objects and a second layer logic implemented by the second NN layer;
providing the second set of skip objects to the second set of layer outputs via the fourth set of router outputs, wherein the second set of skip objects and the second set of processed objects forms a third set of data objects; and
determining the one or more predictions based on a third set of data objects and a third layer logic implemented by the third NN layer, wherein the third set of data objects includes the second set of processed objects and the second set of skip objects.

3. The computing system of claim 1, wherein the first NN layer is a first feed-forward layer (FFL) of a set of NN layers of the NN.

4. The computing system of claim 3, wherein the first set of non-skip objects is an ordered set and the operations further comprise:
subdividing the first set of non-skip objects into a first subset of non-skip objects and a second subset of non-skip objects based on an order of the first set of non-skip objects;
providing the first subset of non-skip objects to the first FFL; and
providing the second subset of non-skip objects to the first FFL;

5. The computing system of claim 4, wherein the first subset of non-skip objects is provided to the first FFL in series with the second subset of non-skip objects being provided to first FFL.

6. The computing system of claim 4, wherein the first subset of non-skip objects includes at least a first non-skip object and a second non-skip object, the second subset of non-skip objects includes at least a third non-skip object and a fourth non-skip object, and the operations further comprise:
providing the first non-skip object and the third non-skip object to a first implementation of the first FFL; and
providing the second non-skip object and the fourth non-skip object to a second implementation of the first FFL.

7. The computing system of claim 4, wherein the first non-skip object is provided to the first implementation of the first FLL in parallel to the second non-skip object being provided to the second implementation of the first FLL and the third non-skip object is provided to the first implementation of the first FLL in parallel to the fourth non-skip object being provided to the second implementation of the first FLL.

8. The computing system of claim 7, wherein the first non-skip object is provided to the first implementation of the first FLL in series with the third non-skip object being provided to the first implementation of the first FLL and the second non-skip object is provided to the second implementation of the first FLL in series with the fourth non-skip object being provided to the second implementation of the first FLL.

9. The computing system of claim 4, wherein a first cardinality of the first subset of non-skip objects and a second cardinality of the second subset of the non-skip objects is indicated by a hyperparameter of the NN.

10. The computing system of claim 1, wherein the first set of data objects is a first ordered set that has a first order, the first set of skip objects is a second ordered set that has a second order based on the first order, and the first set of non-skip objects is a third ordered set that has a third order based on the first order.

11. The computing system of claim 11, wherein the operations further comprise:
forming the second set of data objects based on the first order of the first set of data objects, the second order of the first set of skip objects, and the third order of the first set of non-skip objects such that the second set of data objects is a fourth ordered set that has the first order.

12. The computing system of claim 1, wherein the first NN layer is a first feed-forward layer (FFL) and the NN further includes a self-attention layer and a first layer-normalization (LN) layer, and the operations further comprise:
providing the first set of objects to the first NN layer;
determining a key-value pair for each data object of the first set of data objects based on a first LN logic implemented by the first LN layer;
providing the key-value pair for each data object of the first set of data objects to the self-attention layer;
providing the first set of non-skip objects to the self-attention layer;
generating a self-attention output based on a self-attention logic implemented by the self-attention layer, the key-value pair for each data object of the first set of data objects, and the set of non-skip objects; and
generating the first set of processed objects based on the self-attention output and the first layer logic.

13. The computing system of claim 12, wherein the operations further comprise:
determining a first LN output based on the first LN logic and the first set of data objects;
providing the first LN output to the first skip router; and
subdividing the first set of data objects into the first set of skip objects and the first set of non-skip objects further based on the first LN output.

14. The computing system of claim 12, wherein the operations further comprise:
determining a query for each non-skip object of the first set of non-skip objects;
providing the query for each non-skip object of the first set of non-skip objects to the self-attention layer; and
generating the self-attention output further based on the query for each non-skip object of the first set of non-skip objects.

15. The computing system of claim 14, wherein the set of NN layers further comprises a second LN layer and the operations further comprises:
providing the self-attention output to the second LN layer;
determining a second LN output based on a second LN logic implemented by the second LN layer and a self-attention output;
providing the second LN output to the first FFL; and
generating the first set of processed objects further based on the second LN output and the first layer logic.

16. The computing system of claim 1, wherein each data object of the first set of data objects is a vector embedding of a natural language (NL) token, the NN implements a NL transformer model, and the one or more predictions are associated with one or more NL tasks performed by the NL transformer model.

17. The computing system of claim 16, wherein the NL transformer model is a decoder model.

18. The computing system of claim 1, wherein the first skip logic and the first layer logic are jointly trained via a loss function that includes a first term associated with an accuracy of the one or more predictions and a second term associated with a cardinality of the first set of non-skip objects.

19. The computing system of claim 18, wherein the second term of the loss function generates a larger penalty when the cardinality of the first set of non-skip objects is larger.

20. A computer implemented method comprising:
providing a first set of data objects to a first set of router inputs of a first skip router of a neural network (NN) that comprises a set of NN layers and a set of skip routers, wherein the set of NN layers comprises at least a first NN layer that includes a first set of layer inputs and first set of layer outputs and the set of skip routers comprises at least the first skip router that further includes a first set of router outputs that forward-feed to the first set of layer inputs, and a second set of router outputs that feed-forward to the first set of layer outputs;
subdividing the first set of data objects into a first set of skip objects and a first set of non-skip objects that is disjoint from the first set of skip objects based on a first skip logic implemented by the first skip router and a first context of each data object in the first set of data objects;
providing the first set of non-skip objects to the first NN layer via the first set of router outputs and the first set of layer inputs such that the first NN layer generates a first set of processed objects based on the first NN layer processing the first set of non-skip objects via a first layer logic implemented by the first NN layer, wherein the first set of processed objects is provided to the first set of layer outputs; and
providing the first set of skip objects to the first set of layer outputs via the second set of router outputs, wherein the first set of skip objects and the first set of processed objects forms a second set of data objects;
determining one or more predictions based on the second set of data objects and a second NN layer of the set of NN layers.
